(19) United States
(12) Patent Application Publication
(10) Pub. No.: US 2011/0232141 A1
(43) Pub. Date: Sep. 29, 2011

(54) LOW PROFILE ELECTRONIC DISPLAY GREETING CARDS AND PRODUCTS

(76) Inventors: David Sapp, North Ridgeville, OH (US); David Mayer, Bay Village, OH (US); Allison Marsh, Ravenna, OH (US); Tiger Qiao, Shanghai (CN); Jerry Guo, Shanghai (CN)

(21) Appl. No.: 13/070,662

(22) Filed: Mar. 24, 2011

Related U.S. Application Data
(60) Provisional application No. 61/316,893, filed on Mar. 24, 2010.

(51) Int. Cl. G09F 1/00

(52) U.S. Cl. 40/124.03

(57) ABSTRACT

Low profile electronic display greeting cards combine a traditional paper greeting card and other product constructions with a very low profile multimedia player device which includes a low profile display screen for displaying images and/or video and emitting sound. The low profile and minimalist construction of the greeting card provide the ability to display the cards at mass retail in traditional card pockets, mail or transport the greeting card in a traditional sized greeting card envelope, and provide, at lower cost to the consumer, a disposable electronic greeting card. A multi-panel greeting card body contains and conceals components of the multimedia device, which may include a display screen, a speaker, a circuit board, a microprocessor, a controller, a memory storage device and related circuitry. The greeting card may contain pre-loaded content such as digital audio, video and/or photographs or still images or it may be operative to receive such digital files from an external memory source.

### RELATED APPLICATIONS

This application claims priority to U.S. Provisional Patent Application Ser. No. 61/316,893, filed on Mar. 24, 2010, which is incorporated herein in its entirety.

### FIELD OF THE INVENTION

The present invention is in the field of greeting cards, and mores specifically to low profile electronic display greeting cards and other social occasion and communication products.

### BACKGROUND OF THE INVENTION

The digital age, created by the advent of personal computers, compact digital electronics and multi-media content has made people very accustom to digital communication and messages. While multimedia content, such as digital images, sound and animation is predominantly distributed and accessed over networks such as television, cable, wireless communication networks, over the Internet via the world wide web, and received and viewed on various types of monitors, it is increasingly accessed and viewed on smaller and portable devices such as personal digital assistants (PDAs), wireless telephones or smart phones with screen displays, and flat panel display such as monitors and digital photo frames. Multimedia content is extremely diverse and varied, and provides an infinitely flexible format for expression and communication. It is particularly well suited for sentiment communication and social greetings for all different types of occasions. The ability to use sound and animated or video imagery, in combination with printed matter such as with conventional printed greeting cards significantly enhances the communicative value of social and relational greetings. Although some efforts have been made at combining traditional printed communication and greetings with digital technology and content, the prior art does not include devices or combinations which are sufficiently versatile to accommodate a broad range of content, and which will maintain their utility and entertainment value long after the initial communication.

### SUMMARY OF THE INVENTION

The present invention is directed to a low profile electronic greeting card having: a multi-panel greeting card body, a sound module operative to store and playback an audio and video slideshow, the sound module comprising a display screen, a power source, a speaker, a circuit board with microprocessor and a digital storage device, at least one pre-loaded digital photograph or image contained on the digital storage device, at least one pre-loaded digital audio file contained on the digital storage device, a switch activation mechanism configured to initiate playback of the at least one pre-loaded digital photograph or image and the at least one pre-loaded digital audio file. The sound module is attached to and concealed by the multi-panel greeting card body. The multi-panel greeting card body contains at least one opening thereon through which the display screen is visible. The thickness of the display screen is less than or equal to the power source, speaker, circuit board and digital storage device. In a preferred embodiment the total thickness of the low profile electronic greeting card is approximately 7.3 mm.

In another aspect of the invention, the low profile electronic greeting card contains a paperboard greeting card body having a first panel connected to a second panel along a first fold line and the second panel attached to a third panel along a second fold line, a multi-media player device comprising a display screen, a speaker, a power source, a circuit board, a controller and a memory storage device, the multi-media player device being attached to the second or third panel and concealed within a cavity formed by the second and third panels, at least two digital files saved on the memory storage device and a slide switch located across the first fold line between the first and second panels of the greeting card body, the slide switch operative to playback the at least two digital filed saved on the memory storage device upon moving the first panel away from the second panel along the first fold line.

In still another aspect of the invention, the low profile electronic greeting card contains a multi-panel greeting card body, a multi-media display device attached to and concealed within the multi-panel greeting card, the multi-media display device comprising a display screen, a circuit board, a controller, a microprocessor, a memory storage device and a power source. The card additionally contains a slide switch attached to the multi-panel greeting card, the slide switch operative to initiate playback of digital files located on the memory storage device and an external memory reading device operative to receive digital files from an external device and save them on the memory storage device.

### DESCRIPTION OF THE DRAWINGS

FIG. 1 is a perspective view of the front of the low profile electronic display greeting card of the present invention.

FIG. 2 is a perspective view of the greeting card of FIG. 1, in an open position.

FIG. 3 is a perspective view of the greeting card of FIG. 1 showing the internal electronic components.

### DETAILED DESCRIPTION OF PREFERRED AND ALTERNATE EMBODIMENTS

The low profile electronic display greeting cards of the present disclosure and related inventions, combine traditional paper greeting cards with a very low profile multimedia player device which includes a display screen capable of displaying pre-loaded or uploaded images and speaker for emitting sound. The multimedia player device and associated circuitry are contained between two panels of a greeting card and do not take up any more space or require any additional thickness than a conventional greeting card with sound capabilities. The multimedia player device is powered preferably by batteries, such as disposable lithium batteries. The streamlined card construction and chip set provide a greeting card that can be merchandised in standard greeting card pockets at mass retail, for example in conventional greeting card retail displays. The greeting card provides an electronic alternative to more expensive multimedia greeting cards, while maintaining the disposable nature of a typical greeting card, a thin profile for insertion into a standard greeting card envelope and for displaying on a typical greeting card retail display and a low weight for mailing.

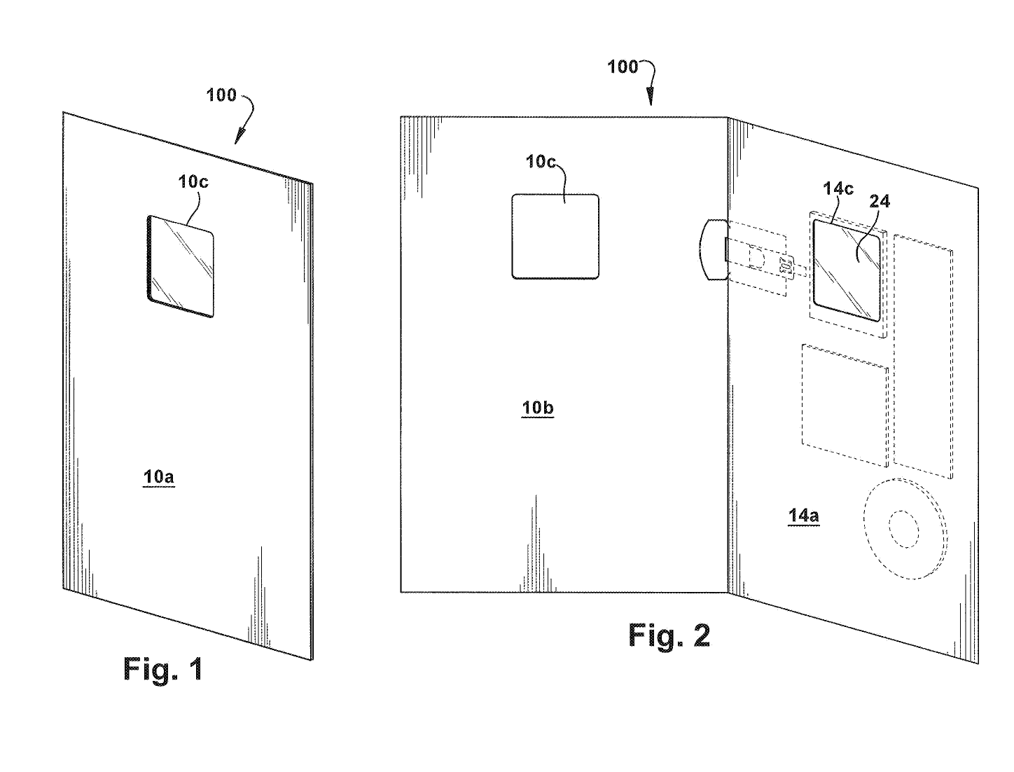

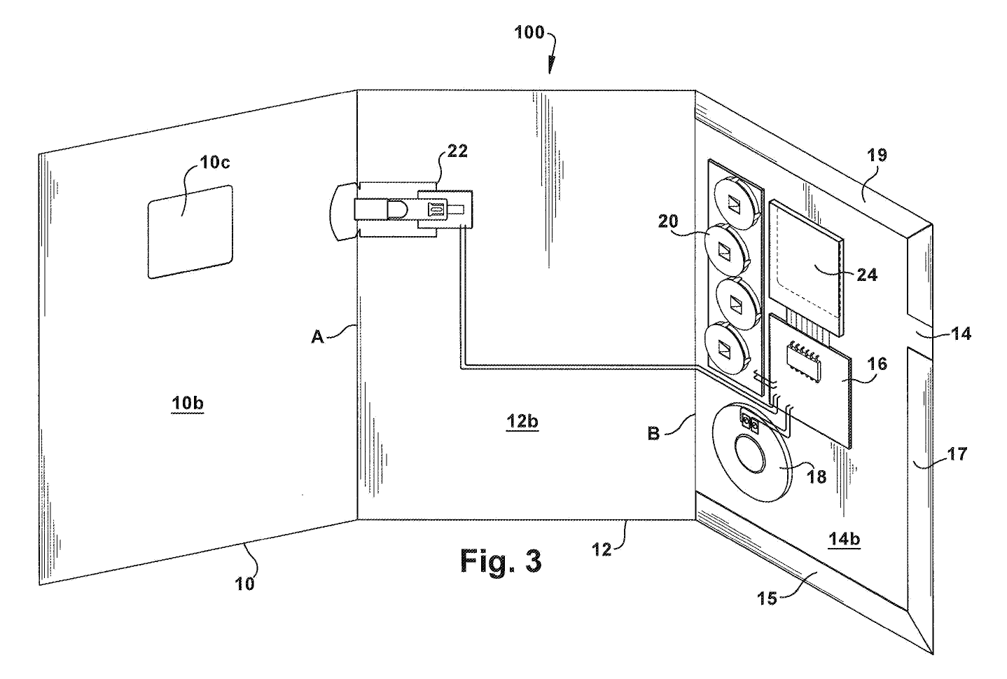

In a preferred embodiment, shown in FIGS. 1-3, the greeting card body 100 has a typical gatefold configuration. A first panel 10 is connected along a first fold line A to a second panel 12 that is connected along a second fold line B to a third panel 14. Each of the panels 10, 12, 14 has a front side 10a, 12a, 14a and a back side 10b, 12b, 14b which is opposite the front side. The components of the multimedia player device are attached, adhesively or otherwise, to either the back surface 12b, 14b of the second 12 or third 14 panel of the greeting card 100. Once the components have been attached to the greeting card 100, the third panel 14 is folded along the second fold line B and attached to the second panel 12 such that the back surface 14b of the third panel 14 is facing the back surface 12b of the second panel 12, thereby concealing the device components therein. The front surface 14a of the third panel 14 serves as the inside right panel of the greeting card 100 and the back surface 10b of the first panel 10 serves as the inside left panel. The front surface 10a of the first panel 10 serves as the front or cover of the greeting card 100 and the front surface 12a of the second panel 12 is the back panel of the greeting card 100. The third panel 14 of the greeting card 100 contains an opening 14c thereon that is sized and positioned relative to the location of the display screen 24 so that the screen 24 can be seen through the opening 14c. An additional opening 10c may be located on the first 10 or front panel of the greeting card 100 which corresponds to the opening 14c in the third panel 14 and the placement of the display screen 24. This allows for instant recognition at retail that the card is an electronic greeting card without having to pick up and open the card. The third panel 14 of the greeting card 100 may have a side tab 15, 17, 19 attached to each free edge of the panel. Once the third panel 14 is folded over the second panel 12 creating a cavity therein for the electronic components or an electronic module, the side tabs 15, 17, 19 may be folded over and attached to the front surface 12a of the second panel 12.

A switch mechanism 22 is used to initiate playback of a multimedia slideshow. Preferably, the switch is a slide switch device 22, which is attached to the greeting card 100 across the first fold line A between the first 10 and second 12 panels of the greeting card 100. When a user opens the greeting card 100 by unfolding the first panel 10 away from the second panel 12 along the first fold line A, the slide switch mechanism 22 is activated and initiates the pre-recorded multimedia slideshow which may include visual images displayed upon the display screen and audio consisting of spoken voice and/or music. The visual images may be synchronized to the music. When the greeting card 100 is closed by folding the first panel 10 back over the second panel 12, the multimedia slideshow is deactivated. While a slide switch is described herein, other switches, such as, for example, magnetic switches, light or touch sensitive switches, spring loaded switches or any other switch mechanism are considered to be within the scope of the present invention.

Components of the multimedia player device, which are consolidated or packaged in an electronic module such as, for example, mounted on a common circuit board, may include, but are not limited to, a flat panel display screen 24, such as an LCD screen, a power source 20 which preferably consists of one or more disposable batteries, an audio speaker, 18 a circuit board 16 with controller and microprocessor, a data storage device and related circuitry. The device may contain one or more pre-recorded slideshows with accompanying audio. A slideshow format may include several consecutive photographs or still images that are displayed on a loop. Representative dimensions of one embodiment of the display screen 24 are between approximately 1.5 and 2.4 inches in width and/or height or thickness. The overall or nominal thickness of the display screen 24 is preferably equal to or less than the vertical profile or thickness of the circuit board and speaker, or of the “tallest” or “thickest” component or structure of the electronic module or on the circuit board 16, so that the display 24 adds no additional thickness to the greeting card 100 when compared to a typical sound producing greeting card with sound generating circuit. This is especially advantageous for an electronic graphics or video-enabled greeting card to have the same nominal thickness or bulk as a common paper greeting card and avoids the need for a larger card construction such as a book-type binding or panel fold.

A representative embodiment of the device can store up to approximately 20 pre-loaded photos or images and between approximately 26 seconds and 2.26 mines of audio or greater, depending on the amount of digital storage provided. Additionally, the multimedia player device may be capable of playing several file formats including but not limited to flash, html, html5, mp3, mp4, .mov, .rp4, .wma, etc. The device, when powered by four disposable lithium batteries 20, is capable of playing the pre-loaded audio/visual content approximately 300 times.

In another embodiment, the low profile electronic greeting card may be operative to receive an upload of digital images, digital video and/or digital sound files from an external memory device such as a personal computer via a USB port or an SD card.

In still another embodiment, the low profile electronic greeting card may be operative to record, save and playback a personalized voice message. The electronic components would additionally include a microphone and switch to initiate a recording session. A saved personalized message may be played back upon the user opening the greeting card or it may be triggered by compression of a push button switch or other event which triggers a user interactive sensor device. The personalized recorded message may be replayed alone or before, after or simultaneously with pre-recorded music or other sound. The internal memory device may additionally contain spoken instructions which instruct the user how to record and save a message.

What is claimed is:

1. A low profile electronic greeting card comprising:
a multi-panel greeting card body;
an electronic module operative to store and playback an audio and video slideshow, the electronic module comprising the components of a display screen, a power source, a speaker, a circuit board with microprocessor, and a digital storage device;
at least one pre-loaded digital photograph or image contained on the digital storage device;
at least one pre-loaded digital audio file contained on the digital storage device;
a switch activation mechanism configured to initiate playback of the at least one pre-loaded digital photograph or image and the at least one pre-loaded digital audio file;
the sound module attached to and concealed by the multi-panel greeting card body;
the multi-panel greeting card body having at least one opening thereon through which the display screen is visible,
wherein a thickness of the display screen is less than or equal to a thickness dimension of the components of the electronic module.

2. The low profile electronic greeting card of claim 1, wherein the multi-panel greeting card body is made of paper or paperboard.

3. The low profile electronic greeting card of claim 1, wherein the switch activation mechanism is a slide switch which is triggered upon opening the greeting card.

4. The low profile electronic greeting card of claim 1, wherein the at least one pre-loaded digital audio file contains music.

5. The low profile electronic greeting card of claim 4, wherein the display of the at least one pre-loaded digital photograph or still image is synchronized with the music.

6. The low profile electronic greeting card of claim 1, wherein the switch activation mechanisms is a push-button.

7. The low profile electronic greeting card of claim 1, wherein the display screen is visible through the front of the greeting card.

8. The low profile electronic greeting card of claim 1, wherein the display screen is approximately between 1.5 and 2.4 inches wide.

9. A low profile electronic greeting card comprising:
a paperboard greeting card body having a first panel connected to a second panel along a first fold line and the second panel attached to a third panel along a second fold line;
a multi-media player device comprising a display screen, a speaker, a power source, a circuit board, a controller, and a memory storage device, the multi-media player device attached to the second or third panel and concealed within a cavity formed by the second and third panels;
at least two digital files saved on the memory storage device; and
a slide switch located across the first fold line between the first and second panels of the greeting card body, the slide switch operative to playback the at least two digital files saved on the memory storage device upon moving the first panel away from the second panel along the first fold line,
wherein the thickness of the low profile electronic greeting card is approximately 7.3 mm.

10. The low profile electronic greeting card of claim 9, wherein one of the at least two digital files is a digital audio file.

11. The low profile electronic greeting card of claim 9, wherein one of the at least two digital files contains one or more digital photographs or still images.

12. The low profile electronic greeting card of claim 9, wherein one of the at least two digital files contains digital video.

13. The low profile electronic greeting card of claim 9, wherein the third panel of the greeting card body contains an opening thereon through which the display screen is visible.

14. The low profile electronic greeting card of claim 13, wherein the first panel of the greeting card body contains an opening thereon through which the display screen is visible.

15. The low profile electronic greeting card of claim 9, wherein the thickness of the display screen is less than or equal to the thickness of the power source, the speaker and the circuit board.

16. A low profile electronic greeting card comprising:
a multi-panel greeting card body;
a multi-media display device attached to and concealed within the multi-panel greeting card, the multi-media display device comprising a display screen, a circuit board, a controller, a microprocessor, a memory storage device and a power source;
a slide switch attached to the multi-panel greeting card, the slide switch operative to initiate playback of digital files located on the memory storage device; and
an external memory reading device operative to receive digital files from an external device and save them on the memory storage device.

17. The low profile electronic greeting card of claim 16, wherein the multi-panel greeting card body is made of paper or paperboard.

18. The low profile electronic greeting card of claim 16, wherein the external memory reading device is a USB port.

19. The low profile electronic greeting card of claim 16 further comprising one or more pre-loaded digital files located on the memory storage device.

20. The low profile electronic greeting card of claim 16, wherein the display screen is visible through the front of the greeting card.
